(19) United States
(12) Patent Application Publication
(10) Pub. No.: US 2023/0013275 A1
(43) Pub. Date: Jan. 19, 2023

(54) TAKEOFF AND LANDING SYSTEM

(71) Applicant: AERONEXT INC., Tokyo (JP)

(72) Inventor: Yoichi SUZUKI, Tokyo (JP)

(21) Appl. No.: 17/785,006

(22) PCT Filed: Dec. 20, 2019
(86) PCT No.: PCT/JP2019/050194

§ 371 Date: Jun. 13, 2022

(51) Int. Cl. B64F 1/36; B64D 35/04

(52) U.S. Cl. CPC B64F 1/36; B64D 35/04; B64C 39/024

(57) ABSTRACT

To provide a technique for accurately taking off and landing at the takeoff and landing port of an aircraft. The takeoff and landing system according to the present invention includes an aircraft having a takeoff and landing unit 5 with a takeoff and landing area and having a predetermined outer diameter in a side surface view, and a takeoff and landing port 10 wherein, when the takeoff and landing area of the takeoff and landing unit 5 of the aircraft 1 is included in and makes contact with the takeoff and landing surface of the takeoff and landing port 10, a predetermined outer diameter in a side surface view is larger than the length at the outer edge of the takeoff and landing surface.

### TECHNICAL FIELD

The present invention relates to a takeoff and landing system that includes an aircraft, and a takeoff and landing port for taking off or landing the aircraft.

### BACKGROUND ART

In relation to the operation of an unmanned aircraft that flies using the power of a battery, it is described that the operation plan of the unmanned aircraft includes a power supply step for charging the battery (for example, Patent Literature 1).

### PRIOR ART LIST

### Patent Literature

[Patent Literature 1] International Publication WO2019/135271

### SUMMARY OF THE INVENTION

### Technical Problem

However, from the viewpoint of safety and the like, there is a demand to establish a technique for accurately taking off or landing at the takeoff and landing port of an aircraft, but the conventional technique cannot fully meet the demand.

The present invention has been made in view of such circumstances, and an object of the present invention is to provide a technique for accurately taking off or landing an aircraft at a takeoff and landing port.

### Technical Solution

According to the present invention, there is provided a takeoff and landing system comprising: an aircraft having a takeoff and landing unit with a takeoff and landing area and having a predetermined outer diameter in a side surface view; and

a takeoff and landing port having an outer edge that is equal to or greater than the takeoff and landing area, and is less than the predetermined outer diameter.

### Advantageous Effects

According to the present invention, a technique for accurately taking off and landing at the takeoff and landing port of the aircraft can be provided.

### BRIEF DESCRIPTION OF THE DRAWINGS

FIG. 1 is a schematic diagram showing a state (A) of a conventional aircraft when ascending and a state (B) of the aircraft when travelling.

FIG. 2 is a diagram showing a state of the aircraft according to the present embodiment when ascending and hovering.

FIG. 3 is a diagram of the aircraft of FIG. 2 as viewed from above.

FIG. 4 is a diagram showing the state of the aircraft of FIG. 2 when travelling.

FIG. 5 is a diagram showing a state of the aircraft of FIG. 2 when descending.

FIG. 6 is a diagram showing a state after the aircraft of FIG. 2 has left the load (when ascending again).

FIG. 7 is a general functional block diagram of an aircraft.

### DETAILED DESCRIPTION OF THE EMBODIMENTS

The invention according to the present embodiment has the following configuration.

[Item 1]

A takeoff and landing system comprising:

an aircraft having a takeoff and landing unit with a takeoff and landing area and having a predetermined outer diameter in a side surface view; and

a takeoff and landing port wherein, when the takeoff and landing area of the takeoff and landing unit of the aircraft is included in and makes contact with the takeoff and landing surface of the takeoff and landing port, a predetermined outer diameter in a side surface view is larger than the length at the outer edge of the takeoff and landing surface.

[Item 2]

The takeoff and landing system according to Item 1, wherein:

the aircraft includes at least a plurality of rotor blades and a motor for driving the rotor blades, and

the outer edge is arranged on the inner side than the position of the motor when viewed from above.

[Item 3]

The takeoff and landing system as set forth in Item 1 or 2, wherein:

when the aircraft lands at the takeoff and landing port, the center of the predetermined outer diameter in the front-rear direction of the aircraft is arranged in front of the traveling direction of the aircraft than the center of the outer edge in a side surface view.

### Details of Embodiments

Hereinafter, a takeoff and landing system according to the embodiments of the present invention will be described with reference to the accompanying drawings.

<Explanation of Takeoff and Landing System>

A takeoff and landing system according to the present embodiment includes N aircrafts (N is an arbitrary integer value of 1 or more), and M takeoff and landing ports (M is an arbitrary integer value of 1 or more independent of N). Additionally, for the purpose of simplifying the explanation, a case where one aircraft 1 lands on one takeoff and landing port 10 will be described below.

<Explanation of Aircraft>

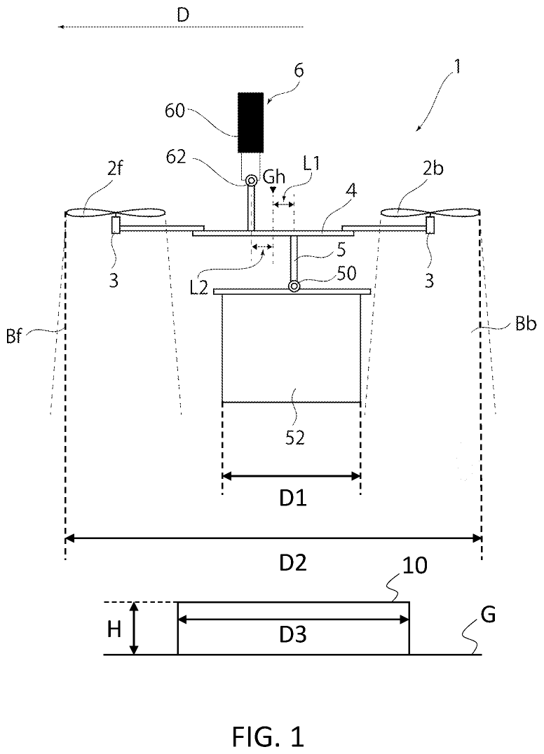

As shown in FIG. 1, the aircraft 1 includes a propeller 2 (lift generator: rotor blade), a motor 3 for rotating the propeller 2, an arm 4 mounted with a motor 3, a mounting unit 5 (takeoff and landing unit), which has a takeoff and landing area and at the same time, mounts a load 52, and a battery unit 6 as a counterweight. The aircraft 1 has a predetermined outer diameter D2 in a side surface view. In the present embodiment, an XYZ three-dimensional orthogonal coordinate system set for a moving body that makes the front-rear direction as an X-axis direction, the left-right direction (or horizontal direction) as a Y-axis direction, and the up-down direction (or vertical direction) as a Z-axis direction is defined. The aircraft 1 makes the direction of arrow D (+X direction) in the figure (details will be described later) as a traveling direction.

In the following explanation, the terms may be selectively used according to the following definitions.

Front-rear direction: +X direction and X direction

Up-down direction (or vertical direction): +Z direction and Z direction

Left-right direction (or horizontal direction): +Y direction and Y direction

Travelling direction (forward): +X direction

Reverse direction (backward): −X direction

Ascending direction (upward): +Z direction

Descending direction (downward): −Z direction

The propeller 2 receives an output from the motor 3 to rotate. The rotation of the propeller 2 generates a propulsive force for taking off the aircraft 1 from the starting point, moving it horizontally, and taking off and landing it at a destination. Further, the propeller 2 can rotate rightward, stop, and rotate leftward.

The propeller 2 of the present invention has blades. The number of blades (rotors) may be an arbitrary number (e.g., 1, 2, 3, 4, or more blades). Further, the shape of the blade may be any shape such as a flat shape, a curved shape, a twisted shape, a tapered shape, or a combination thereof. Further, the shape of the blade can be changed (for example, stretching, folding, bending, etc.). The blades may be symmetric (having the same upper and lower surfaces) or asymmetric (having different shaped upper and lower surfaces). The blades can be formed to have a geometric shape suitable for generating dynamic aerodynamic forces (e.g., lift, thrust) when an air foil, a wing, or a blade moves in the air. The geometric shape of the blade can be appropriately selected to optimize the dynamic air characteristics of the blade, such as increasing lift and thrust and reducing drag.

The motor 3 causes the rotation of the propeller 2, and for example, the drive unit can include an electric motor, an engine, or the like. The blades can be driven by the motor and rotate around the axis of rotation of the motor (e.g., the major axis of the motor) in a clockwise and/or counterclockwise direction.

The blades are all rotatable in the same direction or can rotate independently. Some of the blades rotate in one direction and the other blades rotate in the other direction. The blades can be all rotated at the same rotation speed, or can also be rotated at a different rotation speed. The number of rotations can be automatically or manually determined based on the dimensions (e.g., size, weight) and the control state (speed, moving direction, etc.) of the moving body.

The arm 4 is a member that supports the corresponding motor 3 and propeller 2, respectively. The arm 4 may be provided with a color-displaying body such as an LED to indicate the flight state, flight direction, and the like of the rotary wing aircraft. The arm 4 according to the present embodiment can be formed of a material appropriately selected from carbon, stainless steel, aluminum, magnesium, or the like, or an alloy or combination thereof.

The mounting unit 5 is a mechanism for mounting and holding the load 52. The mounting unit 5 always maintains the state in a predetermined direction (e.g., horizontal direction (vertically downward)) so that the position and orientation of the loaded load 52 can be maintained.

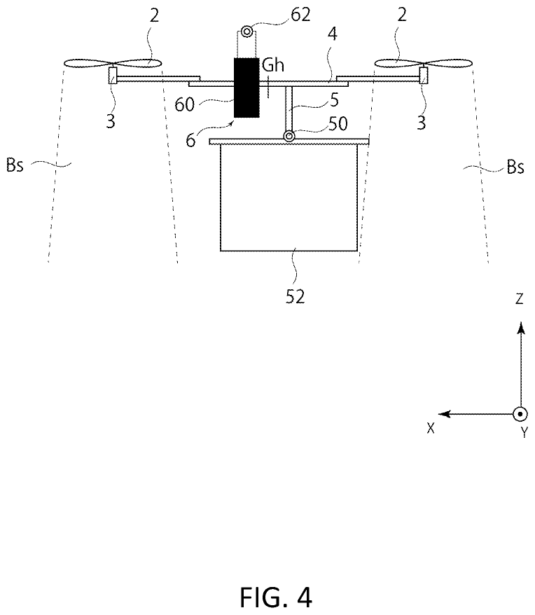

More specifically, the mounting unit 5 has a hinge (gimbal) 50, and the load 52 is configured to be folded according to the inclination of the aircraft 1 with the hinge 50 as a fulcrum. The size of the angle at which the hinge 50 is bent is not particularly limited. For example, as shown in FIG. 4, horizontal even when the aircraft 1 flies in a forward tilting posture, it is sufficient that the position and direction of the load 52 may be maintained horizontal. Thereby, the load 52 is always maintained in a state of being suspended downward in the vertical direction, and can be delivered to the destination while maintaining the position and state at the starting point. The hinge 50 according to the present embodiment is movable only in the front-rear direction, which is the same direction as the traveling direction. However, the hinge 50 may be movable in the left-right direction in addition to the front-rear direction.

Moreover, the operation of the hinge 50 may be controlled by a motor or the like. For example, a motor or the like can control the operation of the hinge 50 so as to maintain the position and direction of the load 52 horizontally. Thereby, the wobbling (natural vibration, etc.) of the load 52 at the time of takeoff, flight, or landing is more prevented.

The shape and mechanism of the mounting unit 5 is not particularly limited, and any kind can be used as long as they can house and hold the load 52, and the load 52 mounted on the first mounting unit 30 is inclined or can maintain its position. However, as will be described later, the load 52 may have a shape that fits in the takeoff and landing unit 10. That is, in such a takeoff and landing system, the shape of the load 52 can be determined depending on the shape of the takeoff and landing port 10. For example, if the shape of the takeoff and landing port 10 is rectangular or substantially rectangular, the shape viewed from above of the load 52 may also be rectangular or substantially rectangular. Further, even if the shape of the takeoff and landing port 10 is rectangular or substantially rectangular, the shape viewed from above of the load 52 may be a shape such as a circle or an ellipse.

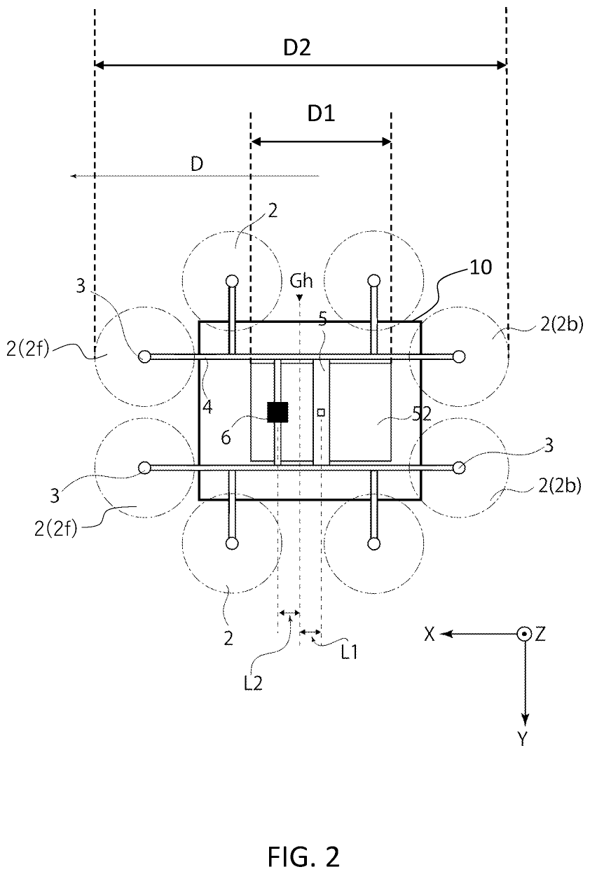

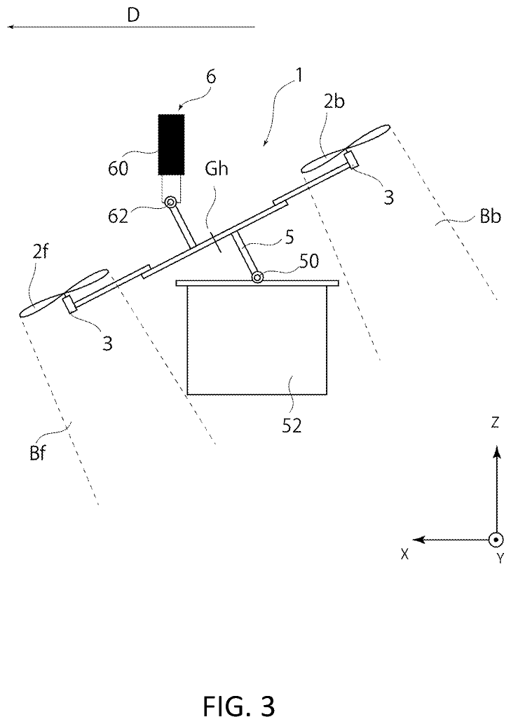

As shown in FIGS. 2 and 3, the mounting unit 5 according to the present embodiment is provided rearward in the traveling direction D by a predetermined distance L1 from the center Gh in the front-rear direction of the aircraft 1. The predetermined distance L1 is set so that the load 52 does not overlap in the vertical direction with the circular region generated at least by the rotation of the rear propeller 2b (see the area indicated by the dashed dotted line of propeller 2b in FIG. 3), even if only partially. In other words, the predetermined distance L1 is set to a value such that the rotating propeller 2 and the load 52 do not overlap when viewed from above the propeller 2. More preferably, the load 52 is provided at a position that is not affected by the wake region Bb generated from the rear propeller 2b. The mounting unit 5 can be provided at an arbitrary position on the arm. The position can be changed by slide-moving after mounting.

The battery unit 6 has a battery 60 such as a lithium ion secondary battery (Li—Po battery or the like) and a hinge 62. The battery unit 6 according to the present embodiment is provided at least in front of the center of gravity, and has a function as a counterweight that balances in the front-rear direction with the above-mentioned mounting unit 5. The details of the function will be described later. The hinge 62 is configured so that the battery 60 bends in the front-rear direction with the hinge 62 as a fulcrum. The angle at which the hinge 62 is bent is not particularly limited. The hinge 62 has a motor (not shown) for controlling the direction of the hinge 62, and the orientation of the battery 60 can be changed according to an instruction from the control unit (not shown: described later). The hinge 62 according to the present embodiment is movable only in the front-rear direction, which is the same direction as the traveling direction. However, it may be movable in the left-right direction.

<Takeoff and Landing Port>

The takeoff and landing port 10 is a device that is arranged at a place where the aircraft 1 can take off and land, which is a device for taking-off and landing the aircraft 1. The takeoff and landing port 10 has a stage on which a support column is projected from a base surface G such as the ground, the roof of a building, and the deck of a ship. The support column for supporting the stage have a height H in the direction perpendicular to the base surface G. The takeoff and landing port 10 can function as a delivery destination for the load 52 mounted on the aircraft 1. Further, the takeoff and landing port 10 may function as an external power supply connection portion for charging the battery 60 mounted on the aircraft 1. Specifically, after landing, the electrode on the aircraft 1 side and the electrode on the takeoff and landing port 10 side come into contact with each other, and can perform power supply to the battery 60.

The takeoff and landing port 10 has a predetermined outer diameter D2 larger than the length at the outer edge D3 of the takeoff and landing surface in a side surface view, when the takeoff and landing area D1 of the mounting unit 5 (takeoff and landing unit) of the aircraft 1 is included in and makes contact with the takeoff/landing surface of the takeoff and landing port 10. Here, in the present specification, the takeoff and landing area D1 represents a distance along one horizontal direction from the front end to the rear end of the load 52. The outer diameter D2 represents a distance from the end part in the case of being on the outermost side of the front propeller 2f kept in a horizontal state, similarly, to the end part in the case of being on the outermost side of the rear propeller (2b) kept in a horizontal state, in a side surface view orthogonal to the one horizontal direction. The outer edge D3 represents the distance along the horizontal direction from the front end to the rear end of the takeoff and landing port 10 in a side surface view orthogonal to the horizontal direction. The takeoff and landing port 10 may have a flat surface.

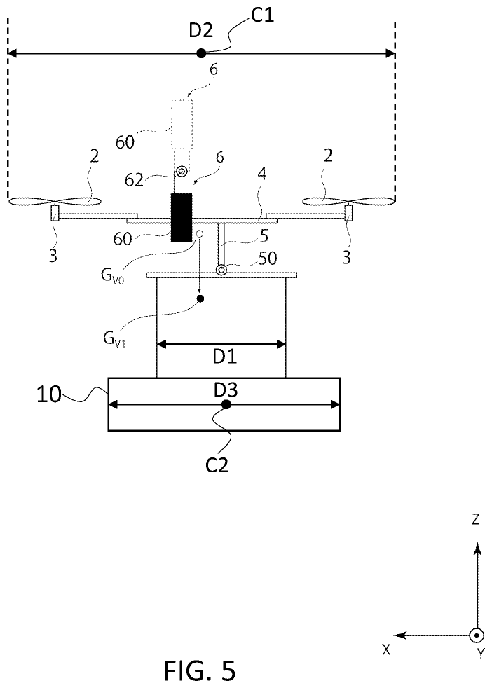

The outer edge D3 may be arranged on the inner side than the position of the motor 3 when viewed from above. With this arrangement, when the aircraft 1 takes off and lands at the takeoff and landing port 10, the turbulent flow generated by the natural wind at the takeoff and landing port 10 when the aircraft 1 approaches, and the wind blown down from the propeller 2 hardly makes contact with the takeoff and landing port 10, thereby taking off and landing the aircraft 1 in a balanced manner. When the aircraft 1 lands at the takeoff and landing port 10, the aircraft 1 tends to float and change its posture due to the ground effect. Therefore, it is preferable that the expected landing area (the area of reference numeral 10 surrounded by the thick line in FIG. 2) is a horizontal or near-horizontal surface that is as wide as possible. As shown in FIG. 5, when the aircraft 1 lands at the takeoff and landing port 10, the center C1 of the outer diameter D2 is placed in front of the traveling direction of the aircraft 1 rather than the center C2 of the outer edge D3 when viewed from the side. Here, as described above, the mounting unit 5 according to the present embodiment is provided rearward in the traveling direction D by a predetermined distance L1 than the center Gh in the front-rear direction of the aircraft 1. That is, the load 52 can be arranged at any position as long as it is not affected by the wake region Bb generated from the rear propeller 2b. When the aircraft 1 lands at the takeoff and landing port 10, it is preferable to arrange the load 52 and the takeoff and landing port 10 in a place that needs to be precisely aligned. Therefore, as in the present embodiment, it is preferable that the center line C1 is arranged closer to the front than the center line C2.

<Explanation During Flight>

Subsequently, the flight mode of the aircraft 1 according to the present embodiment will be described with reference to FIGS. 2, 4 to 6. Further, in the following description, in order to clarify the explanation, each of the four modes of ascending, moving horizontally, descending, and ascending again will be described, but a flight mode by a combination of these modes, such as performing horizontal movement while ascending, is naturally included.

<When Ascending>

As shown in FIG. 2, a user operates a transmitter for radio control having an operation unit to increase the output of the motor 3 of the aircraft and increase the rotation speed of the propeller 2. Due to the rotation of the propeller 2, a lift necessary to lift the aircraft 1 is generated vertically upward. When the lift exceeds the gravity acting on the aircraft 1, the aircraft 1 takes off from the warehouse or the depot (not shown) with the load 52 and flies toward the takeoff and landing port 10 to which the load 52 is delivered.

As shown in the figures, the aircraft 1 including the arm 4 is maintained horizontally as a whole when ascending. At this time, the direction of the battery unit 6 is maintained vertically upward. In other words, when the lift generated by each of the propellers 2 is the same, the gravity applied to the aircraft 1 in the front-rear direction coincides with the center of gravity Gh (the rotational moment about the left-right direction around the center of gravity Gh counteracts). Thereby, the aircraft 1 can ascend while keeping a horizontally level state.

In addition, it is possible for the direction of the battery unit 6 to be changed depending on the weight of the load 52. That is, in the case of a light load, the battery 6 is tilted backward, and in the case of a heavy load, the battery unit 6 is tilted forward to balance.

Further, in the case where the weight applied to the aircraft 1 and the lift generated on the aircraft 1 due to the rotation of the propeller 2 are dynamically balanced, the aircraft 1 can hover. At this time, the altitude of the aircraft 1 is maintained at a constant level. The aircraft 1 according to the present embodiment maintains the same posture as in FIG. 2 described above even during hovering.

<When Moving Horizontally>

In the case where the aircraft 1 travels in the horizontal direction, the aircraft 1 is controlled so that the number of revolutions of propellers 2 located rearward in the traveling direction is greater than the number of revolutions of propellers 2 located forward in the traveling direction. Therefore, as shown in FIG. 4, when moving horizontally in the traveling direction, the aircraft 1 has a posture of leaning forward. In this case, the battery unit 6 is balanced by falling behind the hinge 62. At this time, due to the presence of the hinge 50, the direction of the load 52 is kept horizontal.

As can be understood in comparison with FIG. 1(B) and FIG. 4, since the mounting unit 5 is located rearward the center of gravity Gh, the load 52 is not located in the wake regions Bf and Bb of the propeller 2f and the propeller 2b. Therefore, according to the aircraft 1 of the present embodiment, it is possible to increase the flight efficiency at least when traveling in the horizontal direction.

<When Descending (at the Time of Landing)>

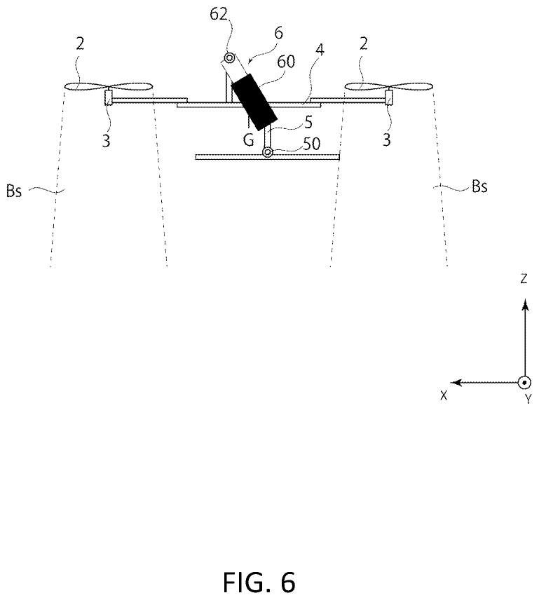

As shown in FIG. 5, when descending, the battery unit 6 rotates with respect to the hinge 62 to face downward. When an upward force is applied to a general aircraft 1 due to an updraft, there is the risk of crashing due to the aircraft 1 losing balance and may crash. However, since the aircraft 1 causes the battery unit 6 to be facing vertically downward before descending, the center of gravity of the aircraft 1 is lowered in the vertical direction (see position GV0 and GV1 before the movement of the battery unit 6 schematically shown in FIG. 6). By lowering the center of gravity of the aircraft 1, the upward force applied to the aircraft 1 can be canceled out by the rising airflow. In this manner, the aircraft 1 according to the present embodiment can also counter the force generated by the rising airflow by appropriately combining means for lowering the center of gravity Gh of the aircraft 1. The stage protruding from the base surface G facilitates the confirmation of the takeoff and landing port 10 which is the landing target of the aircraft 1 from the sky, and enables landing on the stage.

The aircraft 1 lands at the takeoff and landing port 10 and lowers the load 52 mounted on the mounting unit 5 to the takeoff and landing port 10. That is, the aircraft 1 and the load 52 are separated at the takeoff and landing port 10. Separation of the aircraft 1 and the load 52 is performed by separating the load 52 from the mounting part 5. The aircraft 1 according to the present embodiment does not have landing legs in order to reduce the weight. Therefore, when landing, the mounted load 52 itself has the function of landing legs.

Usually, immediately after the load L is separated from the aircraft 1, it is considered that the payload becomes small, and the center of gravity of the aircraft 1 is instantaneously moved upward. However, as described with reference to FIG. 6, the aircraft 1 changes its direction so that the battery unit 6 faces vertically downward after arriving at a target altitude in the sky, and the center of gravity of the lift (hereinafter referred to as the “lift center”) generated by the propeller 2 is changed to be positioned vertically downward from the center. For this reason, even after the load 52 is separated from the aircraft 1, the position of the center of gravity can still be positioned below the lift center in the vertical direction.

<When Ascending Again>

As shown in FIG. 6, after the load 52 is separated from the mounting part 5, the battery unit 6 further rotates rearward, Thereby, it is possible for the aircraft 1 to balance out the change of the center of gravity due to the separation of the load 52. The battery unit 6 in the present embodiment includes a lock mechanism (not shown). The lock mechanism locks the battery unit 6 at the position shown in FIG. 6. The aircraft 1 ascends again in this state and returns to a designated place such as the starting point.

In the embodiment described above, the battery unit is used as the counterweight for balancing with the load 52. However, the means for balancing with the load 52 is not limited thereto. For example, the rotation speed of the propeller 2 can be changed.

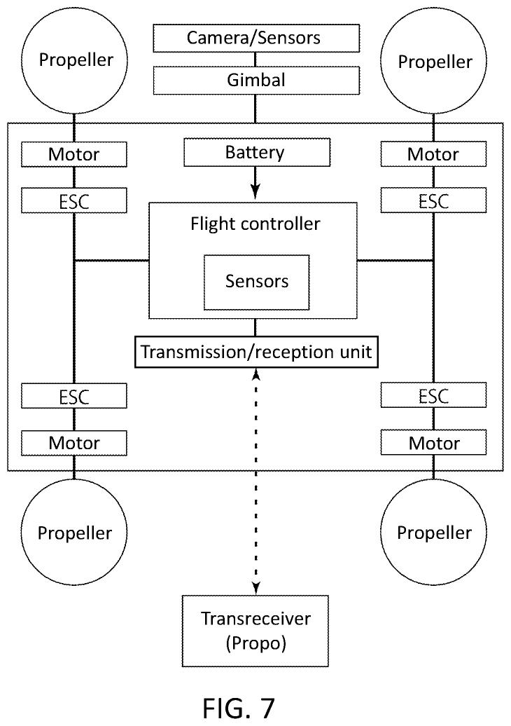

The above-described aircraft has a functional block as shown in FIG. 7. In addition, the functional block of FIG. 7 is a minimum reference structure. A flight controller is a so-called processing device. The processing unit may have one or more processors, such as a programmable processor (e.g., a central processing unit (CPU)). The processing unit has a memory (not shown) and it is possible to access the memory. The memory stores logic, codes, and/or program instructions that can be executed by the flight controller to perform one or more steps. The memory may include, for example, a separable medium such as an SD card or random access memory (RAM) or an external storage device. Data obtained from cameras and sensors may be transmitted directly to the memory and stored. For example, still image dynamic image data taken by a camera or the like is recorded in a built-in memory or an external memory.

The processing unit includes a control module configured to control the state of the aircraft. For example, the control module may control a propulsion mechanism (motor and the like) in order to adjust the spatial arrangement, velocity, and/or acceleration of the aircraft having six degrees of freedom (translational motions x, y, and z, and rotational motions θx, θy, and θz). The control module can control one or more of the states of a mounted part and sensors.

The processing unit can communicate with a transmission/reception unit configured to send and/or receive data from one or more external devices (e.g., a terminal, display device, or other remote controller). The transmission/reception unit can use any suitable communication means such as wired or wireless communication. For example, the transmission/reception unit can use one or more of a local area network (LAN), a wide area network (WAN), infrared, wireless, WiFi, point-to-point (P2P) network, telecommunication network, cloud communication, and the like. The transmission/reception unit can transmit and/or receive one or more of, data acquired by sensors, process results generated by the processing unit, predetermined control data, user command from a terminal or a remote controller, and the like,

Sensors according to the present embodiment may include inertial sensors (acceleration sensors, gyro sensors), GPS sensors, proximity sensors (e.g., LiDAR), or vision/image sensors (e.g., cameras).

The aircraft of the present disclosure can be expected to be used as an aircraft for delivery services, and to be used as an industrial aircraft in a warehouse or a factory. In addition, the aircraft of the present disclosure can be used in airplane-related industries such as multicopters and drones. Furthermore, the present invention can be used in various industries such as security, agriculture, and infrastructure monitoring, wherein the present invention can be suitably used as an aerial photography aircraft equipped with a camera or the like.

The above-described embodiments are merely examples for facilitating the understanding of the present invention, and are not intended to limit the present invention. The present invention can be modified and improved without departing from the gist thereof, and it goes without saying that the equivalents are included in the present invention.

In an upper surface view, the takeoff and landing port 10 may be arranged so as to be inside the line segment connecting the rotation axes of the plurality of motors 3 and so as not to enter the rotation trajectory of the tip of the propeller 2. With such an arrangement, since the propeller 2 can be separated from the ground G by the height H of the takeoff and landing port 10, the air flow between the propeller 2 and the ground G becomes difficult to change, which makes it difficult to generate the so-called ground effect (surface effect), which generates a non-linear thrust and is difficult to control at the time of landing. Thereby, the aircraft 1 can be stably landed at the takeoff and landing port 10. Further, in addition to being obstructive if the height H of the takeoff and landing port 10 is too high, there is a possibility that the load 52 falls from the takeoff and landing port 10. On the other hand, even if the height H of the takeoff and landing port 10 is too low, the ground effect (surface effect) is likely to occur as the distance between the propeller 2 and the ground G becomes shorter, which is thus not preferable. Therefore, it is preferable that the height H of the takeoff and landing port 10 is set to ¼ or more of the rotation radius of the propeller 2. By setting it to ¼ or more, the occurrence of the ground effect (surface effect) can be suppressed to the extent that the takeoff and landing port 10 does not form an obstacle. Further, it is preferable that the height H of the takeoff and landing port 10 is set to ½ or less of the rotation radius of the propeller 2. By setting it to ½ or less, the occurrence of the ground effect (surface effect) can be suppressed while avoiding the possibility that the load 52 falls from the takeoff and landing port 10.

### DESCRIPTION OF REFERENCE NUMERALS

1, 1′: aircraft
2, 2f, 2b: propeller (rotor blade)
3: motor
4: arm (arm part)
5: mounting part (takeoff and landing unit)
6: battery unit
50, 62: hinge
52P: load
60: battery

1. A takeoff and landing system comprising:
an aircraft having a takeoff and landing unit with a takeoff and landing area and having a predetermined outer length in a side surface view, wherein the predetermined length is a distance from the end part in the case of being on the outermost side of the front propeller 2f kept in a horizontal state, similarly, to the end part in the case of being on the outermost side of the rear propeller (2b) kept in a horizontal state, in a side surface view orthogonal to the one horizontal direction; and
a takeoff and landing port, wherein, when the takeoff and landing area of the takeoff and landing unit of the aircraft is included in and makes contact with the takeoff and landing surface of the takeoff and landing port, a predetermined outer length in a side surface view is larger than the length at the outer edge of the takeoff and landing surface.

2. The takeoff and landing system according to claim 1,
wherein the aircraft includes at least a plurality of rotor blades and a motor for driving the rotor blades, and
wherein the outer edge is arranged on the inner side than the position of the motor when viewed from above.

3. The takeoff and landing system according to claim 1,
wherein, when the aircraft lands at the takeoff and landing port, the center of the predetermined outer length in the front-rear direction of the aircraft is arranged in front of the traveling direction of the aircraft than the center of the outer edge in a side surface view.

4. The takeoff and landing system according to claim 2,
wherein, when the aircraft lands at the takeoff and landing port, the center of the predetermined outer length in the front-rear direction of the aircraft is arranged in front of the traveling direction of the aircraft than the center of the outer edge in a side surface view.
